(19) United States
(12) Patent Application Publication
(10) Pub. No.: US 2004/0055953 A1
(43) Pub. Date: Mar. 25, 2004

(54) Production process and composition of an enzymatic preparation, and its use for the treatment of domestic and industrial effluents of high fat, protein and/or carbohydrate content

(76) Inventors: Magali Christe Cammarota, Rio de Janeiro (BR); Denise Maria Guimaraes Freire, Rio de Janeiro (BR); Geraldo Lippel Sant Anna, Jr., Rio de Janeiro (BR); Carlos Russo, Rio de Janeiro (BR); Denise Dias De Carvalho Freire, Rio de Janeiro (BR); Leda Dos Reis Castilho, Rio de Janeiro (BR)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/399,266

(22) PCT Filed: Oct. 15, 2001
(86) PCT No.: PCT/BR01/00124

(30) Foreign Application Priority Data
Oct. 16, 2000 (BR) P10007101-3

(51) Int. Cl. C02F 3/00

(52) U.S. Cl. 210/606

(57) ABSTRACT

The present invention relates to a preparation process and composition of an enzymatic preparation for the treatment of liquid, paste and semi-solid effluents, both domestic and industrial, with high levels of fats, proteins and/or carbohydrates. In accordance with the present invention the enzymatic preparation proposed is produced by a fungus of the genus Penicillium restrictum isolated from agribusiness wastes, obtained at very reduced cost.

### BACKGROUND OF THE INVENTION

The present invention relates to a preparation process and composition of an enzymatic preparation for the treatment of liquid, paste and semi-solid effluents, both domestic and industrial, with high levels of fats, proteins and/or carbohydrates and, more specifically, to a preparation process and composition of an enzymatic preparation for the enzymatic degradation of fats, proteins and/or carbohydrates present in liquid, sludge and semi-solid effluents, both domestic and industrial, capable of facilitating the operation of the subsequent biological stages and improving the efficiency of the treatment of these effluents.

Biological treatment, employing microbial consortia for the degradation of organic matter, is commonplace. Depending on the actuating microbial flora, there exist two modes of treatment: aerobic biological processes, where aerobic heterotrophic bacteria predominate; and anaerobic biological processes, where facultative and, mainly, anaerobic bacteria predominate. The former require oxygen so as to allow the aerobic bacteria to breathe and utilize the residues, and the latter function in a complete absence of oxygen to purify the residues.

Biological processes present a series of advantages, such as: reduced costs when compared to physical or chemical processes; possibility of mineralizing the organic matter present in the effluents (conversion of the organic matter to carbon dioxide and water); the agents involved in the process—the microorganisms—are self-reproducing catalyzers, therefore, once a biomass has been developed in the reactors and provided the ideal conditions for its survival are maintained, the biomass will remain active for an indeterminate period; the majority of biological reactors do not require precise control of the parameters or specialized personnel. All these advantages explain the frequency that biological processes are employed to treat domestic and industrial effluents.

These treatment processes include a retention tank or container in which bacteria and other microorganisms are active, many of which may occur naturally, in a manner as to, at least, partially fragment, or completely decompose the organic waste.

The disposal chain associated with wastes varies, and frequently may include various distinct disposal fractions, each presenting different specific requirements for effective treatment. A typical chain of disposal fractions includes water originating from washing and rinsing operations. Such waters are fairly easy to treat and dispose of, as they only contain a relatively small quantity of organic compounds such as carbohydrates, fats and certain proteins encountered in the composition of detergents and foodstuffs.

Another disposal fraction includes the waters containing human and animal wastes (domestic sewage), which requires adequate treatment before being appropriately disposed of.

Other fractions come from the effluents generated by various industrial activities, such as the production of paints, pulp and paper, chemical and pharmaceutical products, foodstuffs, and petroleum derivates, amongst others. In this case, the disposal also requires actual control, taking into account the diversity of organic and non-organic compounds, many of them toxic, present in these effluents. These effluents include those originating from activities related to agribusiness, such as the processing of dairy products, the processing of meat, waste from poultry, pork and bovine abattoirs, meat-packing, etc.

These effluents contain significant quantities of fats and proteins, and may comprise from 10 to 40% of the total COD (Chemical Oxygen Demand), which is a parameter that expresses the quantity of organic matter of the disposal chain. This quantity increases to an even more significant proportion when considering that the fraction that contains it can be separated from the rest of the disposal chain. In view of the fact that there is an increasing tendency to segregate the disposal chain into fractions, in accordance with their composition and the degree of treatment necessary for their appropriate disposal, side-tracking the least polluted fraction for reuse with little or no additional treatment, and channeling the more polluted fraction to effluent treatment plants, the efficient treatment of these concentrated wastes becomes necessary.

Physicochemical treatments allow the partial removal of the organic load by means of the precipitation of proteins and fats with different chemical compositions such as aluminum sulphate, ferric chloride and ferrous sulphate. However, the cost of these reagents is high and the removal of the soluble COD is slight; this leads to the frequent use of biological processes.

It is known that the fats and proteins present in these effluents possess a low coefficient of biodegradability. Furthermore, the fats may solidify at lower temperatures, causing losses at operational level such as the clogging of the biomass in the reactors and the occurrence of unpleasant odors.

Because they degrade very slowly and due to their permanent presence in certain wastes and in primary treatment systems (less than 50% are retained), the fats cause problems for pumping and aerating systems, provoking the development of filamentous bacteria (genus Nocardia and Mycothrix), a phenomenon known as “bulking”.

In aerobic reactors, the fats promote the build-up of a stable foam on the surface of the aeration tank, which makes the flocculation and sedimentation of the sludge difficult and blocks the gas exchanges indispensable to biological degradation, completely impeding the transfer of oxygen in the aeration basins; also, they create “agglomerations” or “pellets” within the secondary sludge floccules, rendering sedimentation difficult, creating unpleasant odors and reducing the efficiency of the treating station.

In anaerobic biological reactors, especially, these problems are even more serious. The interest in these processes has been increasing due to their advantages in the treatment of effluents with an elevated organic load, apart from not requiring aeration equipment, producing less sludge than the aerobic process and requiring a relatively small area. The treatment of effluents with high levels of fat and protein in anaerobic reactors may present a series of problems such as floatation and/or the development of sludge with different physical characteristics and low activity. The floatation of the sludge causes a loss of the biomass through the outlet of the reactor, thus reducing the quantity of the biomass within the reactor and diminishing the efficiency of the treatment. Depending on the drag rate of the biomass, there may even occur an emptying of the reactor, a phenomenon known as “washout”. The adsorption of the fat on the surface of the anaerobic sludge may limit the transport of soluble substrates to the biomass and, consequently, reduce the conversion rate of the substrates.

To avoid these problems caused by the presence of fat, it becomes necessary to employ devices for the retention of fat before it enters the reactors. Amongst these devices, it is possible to mention fat boxes, normally present at the entry of treating stations, water-oil separators and floatation units. These latter are more sophisticated units, in which the effluent to be treated is introduced to a stabilization area so that the ascensional velocity of the fats is greater than the flow of the effluent. Thus, in this manner, the floatation of the fat is obtained, which can then easily be removed by manually or mechanically scraping the surface.

In the case of floatation units, small air bubbles are introduced at the bottom to lift the fatty matter to the surface. The fats that are not retained by these units, notably the dissolved and/or emulsified fats, continue in the effluent towards the treating system. Experience has shown that the presence of the fats that are not retained by the retention units lead to numerous inconveniences.

Treating processes for effluents and sludge using enzymes or microbial cultures producing specific enzymes have already been used for a number of years to reduce the treatment or stabilization time when compared to conventional methods.

There exist state of the art patents that describe various processes for degrading complex organic matter (fats, proteins, starch, cellulose, etc.) through the use of biological compositions constituted by microorganisms and/or enzymes.

The use of enzymes to improve the biodegradability of microbial sludge is proposed in British patent No. 1565335, of Aug. 2, 1976. In this patent, particles of sludge containing fat, grease and oil are comminuted and mixed with water to form a mud. This mud is mixed and aerated and then maintained at temperatures between 50 and 70° C. to activate the thermophilic microorganisms contained in it. The addition of enzymes in a quantity of up to 5% (by weight) allows a degradation of more than 90% of the organic substances present in this mud.

British patent No 2167399A, filed on Nov. 20, 1984, describes a process for the enzymatic treatment of organic substances and biomass, characterized by the fact that substances with between 0.01 and 1% (based on the dry weight of the organic substances) of hydrolytic enzymes, are fed into an agitated reactor, at a temperature between 30 and 60° C., for between 30 minutes to 24 hours. The purpose of the invention is to obtain a high rate of decomposition with small quantities of allochthonous enzymes, so as to improve the hydroextraction properties of enzymatically stabilized sludge, in a manner that, when compared with the conventional stabilization methods (putrefaction/fermentation, aerobic stabilization), no disadvantages occur in terms of hydroextraction performance and energy consumption.

French patent No. 2659645, filed on Mar. 13, 1990, relates a degradation procedure, by biological means, for the fatty matters contained in residuary waters. The procedure is characterized by the introduction of lipase producing bacteria into the fat box of the treating system. The bacteria are fixed to a support material and enclosed in a type of bag of rot-proof material that is immersed close to the surface of the fat box.

The addition of commercial alkaline proteolytic enzymes, derived from Bacillus licheniformes, in the anaerobic stage of the bacterial digestion process to improve the sedimentation of the biomass is described in U.S. Pat. No. 4,981,592, of Jan. 1, 1991. The enzymes are added in quantities of 0.001 to 0.05% (by volume of the aqueous organic medium) and the medium is maintained at a pH between 6.5 and 7.5. The beneficial effect of the enzymes is more pronounced at temperatures from 30 to 60° C. The enzyme remains in contact with the material that is being digested anaerobically for a period of time sufficient to increase the rate of sedimentation of the sludge, thus obtaining a more rapidly digested and clearer effluent.

U.S. Pat. No. 5,019,267, of May 28, 1991, describes the conditioning of liquid organic substances and biomass, particularly sludge from domestic sewage treatment plants. With the use of chelating agents and one or more enzymes, in a proportion of 0.001 to 1.5% (based on the dry weight of the organic matter), organic substances are degraded in an aerobic reactor for periods from 0.5 to 20 hours, whilst maintained at temperatures from 30 to 60° C.

French patent application No. 2669916, filed on Nov. 30, 1990, proposes a procedure for biologically degrading fat and fatty waste by means of placing these materials in a degradation vat containing activated sludge proceeding from the treatment of the degreased residuary waters. Air, nitrogen and phosphorous are added to the vat with the fats and are maintained in a stationary condition for a period around 10 days. According to the inventors, the proposed procedure results in an elimination of more than 95% of the fats, with a concomitant reduction of the COD and of the level of solids. However, despite these good results, the residence time and the necessary aeration rates considerably increase the costs of the treatment.

French patent No. 2684664, filed on Dec. 10, 1991, proposes a method of treatment of effluents with high levels of fats and/or amylaceous materials (starch). The treatment consists in the production, by aerobic fermentation, of cultures enriched with microorganisms, starting from a bioadditive (constituted from the strains Aerobacter aerogenes, Bacillus subtilis, Cellulomonas biazotea, Nitrosomonas sp., Nitrobacter winogradskyi, Pseudomonas denitrificans, P. stutzeri and Rhodopseudomonas palustris), mineral salts, a substrate and water, with control of oxygen and permanent recycling of the contents of the fermentation tank. The culture so obtained is transferred to an aerated fat box, which possesses biofixing elements inside, to facilitate the elimination of the products inhibiting fermentation. The concentration of the bacteria inside the fat boxes is controlled by the flow of the current coming from the fermentation tank and is generally maintained between 10⁷ and 10¹⁰ bacteria per milliliter, for a period of 12 to 72 hours, under an oxygen concentration of 4 to 8 ppm.

Brazilian patent No. 9408267-7 A, filed on Nov. 21, 1994, describes a treatment process employing a composition constituted from Bacillus spp. (a mixture of B. subtilis, B. licheniformes and B. megaterium) combined with a fungal cellulase. The combination of extracellular enzymes produced by the cultures of bacteria and of fungic cellulase results in the synergetic degradation of the cellulose when sewage containing cellulose enters into contact with the composition of the invention. The composition is a broad based system capable of breaking down carbohydrates, fats and proteins as well as cellulose. The cultures of the added bacteria are prepared from spores, and are added at a concentration of at least 10⁴ spores per gram of the composition. The cellulase is commercial, from Sigma or Novo Nordisk, isolated from the fungus Aspergillus niger and employed in a manner as to obtain an activity of at least 1000 CU per gram of composition.

U.S. Pat. No. 5,459,066, of Oct. 17, 1995, relates to the use of a mixture of surface-active agents and enzymes (proteases, amylases, lipases, cellulases and pectinases) for the separation of oily materials from the water used for washing industrial machines. The enzymes are produced by Bacillus subtilis (protease and amylase) and by Aspergillus niger (lipase, cellulase and pectinase) and are employed in different combinations or in the form of a mixture obtained commercially (Amerzyme-A-100, from Applied Biochemists, Milwaukee, Wis.). The enzymes are applied at a concentration that should be between 1 and 200 ppm.

Brazilian patent application No. 9701478-8A, filed on Mar. 25, 1997, describes an aqueous composition for the maintenance of septic tanks that uses enzymes as a particularly efficient active constituent, which accelerates the decomposition of solid disposal materials in a waste treatment system. The composition of this invention contains the following constituents: a complex enzyme/bacteria, an organic solvent and water. It may also include in its formulation additional optional constituents, such as thickeners, pigments, colorants, aromatics, buffer agents and also nutrients for the bacteria. The complex enzyme/bacteria includes at least one enzyme and/or at least one microorganism capable of producing a hydrolytic enzyme. Amongst the enzymes are cellulases, amylases, proteases and lipases.

French patent No. 2762835, filed on Jun. 5, 1998, relates to an invention of a biological product for the purification of residuary waters capable of providing continuous activity. The biological product in question refers to a type of pellet containing at least one of the following bacterial species: Bacillus pumilus, B. subtilis, B. megaterium, B. polymixa or a combination of these; at least one enzyme (lipase of Aspergillus oryzea, amylase of Bacillus amyloliquefaciens and protease of Bacillus licheniformes); a nutrient substance (proteins, glycosides, lipids or their combinations); a detergent (LAS) and a compression agent (a mixture of PVC, ethylcellulose and starch). This latter is progressively disintegrated in contact with water, which permits a progressive and continuous release of the active ingredients contained in the pellet. The biological product contains from 0.5 to 2.0% (by weight) of the bacterial species, derived from a powder at a concentration of 1.1×10¹¹ spores per gram, and of 5 to 20% (by weight) of an enzyme powder, containing 60% of lipase, 20% of amylase and 20% of protease.

One of the disadvantages of employing pure microbial species or combined specific microorganisms in the treatment of effluents and wastes consists in the necessity of continuously adding these elements to the reaction tanks, in view of the rapid modification of the enzymatic capacity of these or even their loss of activity when they are confronted with an environment totally different from that employed for their culture. Many of the problems that frequently occur in treating stations is due to the exacerbated proliferation of undesirable microbial species, to the detriment of the desirable ones that, very often, are added to enhance the efficiency of the treatment. A good example of this is the occurrence or increase of filamentous sludge in biological aerobic treating stations, hindering the sedimentation of the sludge and reducing the quality of the treated effluent. One form of avoiding this problem is the stimulation of the microorganisms of interest or the elimination of the undesirable microorganisms through the addition of nutrients and adequate growth factors and/or inhibiting substances.

U.S. Pat. No. 5,015,385, of May 14, 1991, deals with this subject, proposing the addition of specific growth factors for the bacteria present in the effluent having a capacity to disintegrate or emulsify fats, so as to promote improved bacterial growth without, however, providing a significant nutrient source for the bacteria. The said growth factor consists of a mixture of up to 15 amino acids and carboxylic acids in concentrations of 0.5 to 30 mg per liter each, making the treatment process substantially more expensive.

Another point worth stressing lies in the fact that many of the patents mentioned propose the use of commercially available enzymes, produced by specific microorganisms and very often alien to the applied environment, marketed at rather high cost and which, in practice, give disappointing results in terms of efficiency, apart from the fact that they require constant addition and in high concentrations.

### SUMMARY OF THE INVENTION

Thus, to solve these problems and avoid the inconveniences exposed above, the present invention proposes the implementation of a stage of enzymatic hydrolysis of these fats and/or proteins, before the biological treatment stage, employing an enzymatic composition constituted by lipases, proteases and/or amylases, that will permit a partial degradation of these materials and, consequently, reduce the residence time in the biological reactors, as well as the operational problems mentioned above.

The proposed procedure is based on the fact that a major part of the fatty matters present in the effluents is composed of triglycerides, whose structural formula is the following:

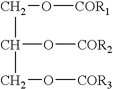

The radicals R₁, R₂ and R₃, that may be identical or different, are residues of fatty acids whose chain, which may be more or less long, may allow more or less ethylenic unsaturation. The greater the degree of saturation of these fatty acids, the higher the tendency of solidifying at ambient temperature. In accordance with the present invention, the triglycerides will be treated by enzymatic means, so as to degrade them, followed by aerobic or anaerobic biological means.

There exist microorganisms, isolated from nature and/or genetically modified in laboratory, capable of synthesizing and excreting enzymes of the hydrolase family—lipases—capable of breaking the C—O chain. However, the introduction of such microorganisms in the treating systems would bring about the problems already mentioned. The triglycerides are degraded very slowly and only at the water-fat interface; their hydrophobic nature and the storage conditions are naturally unfavorable for an availability of sufficient water for microbial development.

In the presence of water and under certain conditions of pH and temperature, the lipases act sequentially on the triglycerides, obeying the following stages:

CH₂—O*COR₁

CH—O—COR₂+H₂O

CH₂—O* COR₃

The fatty acids linked to positions 1 and 3 are attacked and released, whilst the fatty acid linked to position 2 is transferred to position 1.

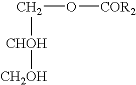

The lipase then acts on position 1:

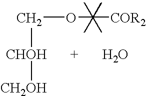

Obtaining, thus, four molecules, namely: glycerol (CH₂OH—CHOH—CH₂OH) and three free fatty acids (R₁—COOH, R₂—COOH and R₃—COOH). The glycerol is converted to pyruvate my means of glycolysis and the fatty acids to acetate through β-oxidation. The molecules thus formed may enter the Krebs Cycle, generating the energy necessary to the microorganisms.

In accordance with the present invention, it is possible to eliminate or significantly reduce the level of triglycerides in the effluents through an enzymatic pretreatment with a solid (fermented waste) or aqueous (enzymatic preparation obtained from fermented waste) composition produced by a filamentous fungus of the genus Penicillium. This pretreatment allows a better activity of the microbial population in the subsequent stage of aerobic or anaerobic biological treatment. Apart from the lipases, the fungus also produces other hydrolytic enzymes such as proteases and amylases, whose production may be intensified according to the characteristics of the effluent to be treated, in other words, effluents with high levels of protein require a greater concentration of proteases in the fermented waste; on the other hand, carbohydrate rich effluents may require greater concentrations of amylases, and so on.

### BRIEF DESCRIPTION OF SEVERAL VIEWS OF THE DRAWINGS

The invention will be described in conjunction with the following drawings, wherein:

FIG. 1 is a plot of COD as a function of Time; and

FIG. 2 is a plot of the concentration of monomeric units (free acids) as a function of the hydrolysis time for an enzymatic preparation of the present invention and a commercial product.

### DETAILED DESCRIPTION OF THE INVENTION

In accordance with the present invention the enzymatic preparation proposed is produced by a fungus of the genus Penicillium isolated from agribusiness wastes, with the production of the hydrolytic enzymes being obtained by a fermentation process in a solid medium at very low cost. The medium for the culture of this hydrolase-producing microorganism consists of the waste from an agribusiness, obtained at very reduced cost. The hydrolytic enzymes are produced as consequence of a fungal fermentation process of this waste. The penetration of the hyphae of the fungus allows access to the different nutrients present in this waste, thus producing different hydrolases (lipases, proteases and amylases).

The ratio of the different hydrolases produced by the filamentous fungus can be controlled by different supplements to the waste of distinct sources of carbon and nitrogen, as well as the variation of the fermentation time, as shown in Table 1 below, which shows the effects of different supplements on the ratio of hydrolases of the waste (termed cake) over the maximum hydrolytic activity obtained at different fermentation times. RTSG means residue from the fat separation tank (RFST).

TABLE 1

| | Maximum Activity | | |
|---|---|---|---|
| | (U/g dry cake) | | |
| Medium | lipase | protease | amylase |
| Babassu cake | 6.5 | 4.8 | 18.8 |
| Cake + Peptone | 27.8 | 5.4 | 28.0 |
| Cake + Olive oil | 17.2 | 4.8 | 31.8 |
| Cake + Starch | 15.7 | 8.0 | 98.7 |
| Cake + Tween 80 | 11.2 | 8.6 | 17.1 |
| Cake + buttermilk | 10.6 | 6.2 | 19.5 |
| Cake + liquid RTSG | 19.8 | 29.9 | 21.3 |
| Cake + solid RTSG | 4.3 | 13.7 | 15.6 |

The enzymatic activity produced was defined in the following manner:

a) Lipase Activity—a unit of lipase activity was defined as the quantity of enzyme that releases 1 μmole of fatty acid per minute under the assay conditions;

b) Protease Activity—a unit of protease activity was defined the quantity of enzyme that produces a unitary difference of absorption per minute between the reactional blank and the sample under the assay conditions; and

c) Amylase Activity—a unit of amylase activity was defined as the quantity of enzyme that produces 1 μmole of sugars reduced per minute under the assay conditions.

Thus, due to the different supplements and conditions of fermentation, the enzymatic preparation may contain lipases showing an enzymatic activity between 4 and 28 units per gram of the fermented waste, proteases showing an enzymatic activity between 5 and 30 units per gram of the fermented waste and amylases showing an enzymatic activity between 17 and 99 units per gram of the fermented waste.

Differing from what is known in the state of the art where the use of microbial combinations or high cost commercial liquid enzymatic preparations are proposed, the present invention proposes the use of a fermented waste in ground solid form or in the form of enzymes extracted from the fermented waste, both obtained at very low cost when compared to the commercial preparations, along with the advantages related below.

With the use of the enzymatic preparation in solid form, it is possible to eliminate the costs of the extraction and retrieval of the enzymes for the liquid phase; the reduction of expenditure with transport, through the elimination of free water; the reduction and/or elimination of the necessity for stabilizing and/or conservative agents, that are, generally, used in liquid enzymatic preparations; and a reduction of the problems with destructive interaction amongst different classes of enzymes.

However, very often, liquid enzymatic preparations have more acceptance on the part of consumers, especially for the treatment of domestic effluents and the cleaning of septic tanks. In this manner, it is possible to modify the composition of the enzymatic formulation, by means of adjusting the culture medium, to minimize the problems of destructive interaction amongst the different classes of enzymes. The enzymatic preparation object of this patent can be produced in liquid form, in a manner that it may be employed in the most diverse applications, by merely altering the conditions of fermentation and retrieval of the preparation. The temperature (30-60° C.) and the time of extraction (5-60 minutes), as well as the volume of the solvent chosen are functions of the proportion of the hydrolases required in the subsequent treating process. In accordance with the variation of these parameters, the enzymatic preparation produced may contain lipases with enzymatic activity from 890 to 6220 units per liter of enzymatic preparation, proteases with enzymatic activity from 1110 to 6670 units per liter of enzymatic preparation and amylases with enzymatic activity from 3780 to 22000 units per liter of enzymatic preparation.

The enzymatic preparation object of the present invention is produced through the inoculation of approximately 10⁷ spores of the fungus Penicillium restrictum per gram of solid medium. The inoculated cake is incubated at 30° C. in an incubator with injection of humid air, in a manner as to maintain the humidity of the cake at between 40 to 70% during the whole fermentation. The cake is fermented for a fermentation time that varies from 24 to 72 hours, in accordance with the proportion of concentration of the hydrolases required subsequently. After this time, the fermented waste is ground and treated to reduce its humidity ratio, so as to obtain the preparation in its solid form with an enzymatic activity within the level required (UI of lipase, protease and/or amylase/g of cake), If the preparation is required in liquid form, then, a buffered aqueous solvent is added for the extraction of the hydrolytic enzymes from solid phase to aqueous phase.

For purposes of demonstration, the following are examples of some of the applications of the present invention.

### EXAMPLE 1

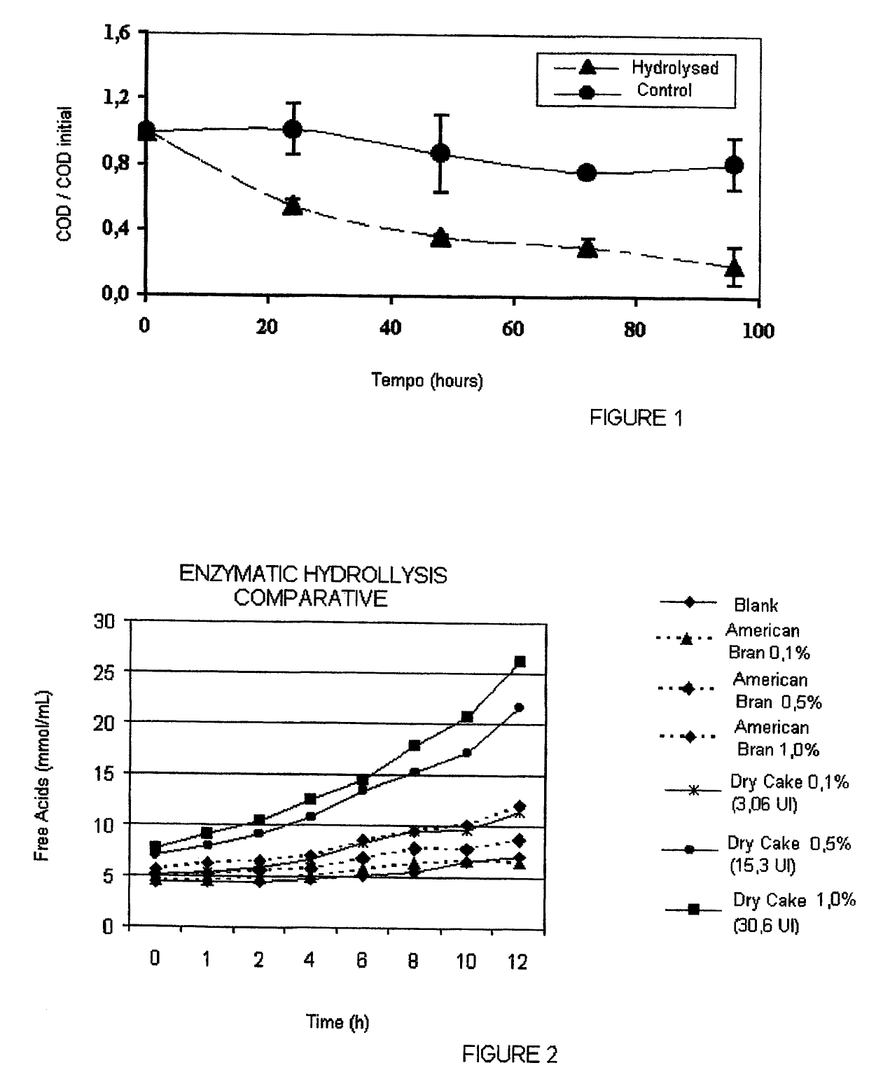

Treatment of effluents with high levels of fats and proteins, whose results can be observed in Tables 2 and 3, and also in FIG. 1.

Typically, the effluents from dairy industries have high organic loads. The lactose, and the fats and proteins found in milk are the principal agents that contribute to increase the organic load in these effluents. Apart from these components, the effluents of these industries also include sanitary sewage and pluvial waters collected at the respective industrial plants. Byproducts such as serum (cheese manufacturing) and buttermilk (butter production), when not used, contribute to the notable increase of the organic load due, mainly, to the presence of fats and proteins in these byproducts.

The results of the degradation of effluents derived from dairy products, rich in fats, by the enzymatic preparation obtained in accordance with the present invention may be observed using the solid preparation at a concentration of 0.01 to 5.0% (humid weight/volume of effluent) or the broth extracted with buffer in the same concentration of lipases as reference (0.04 UI/mL of effluent -1.9 UI/mL of effluent).

The effluents originating from the dairy industry were treated with 10% (v/v) of raw enzymatic broth obtained from fermentation in solid medium. The preliminary treatment consisted of the hydrolysis of the effluent during 2 to 12 hours, at temperatures between 30 and 35° C. Four effluents were tested, each with different initial concentrations of fat: 180, 450, 900 and 1200 mg per liter. The quantity of biological polymers forming units (fatty acids in the case of triglycerides) having greater biodegradability, tripled compared with the effluent, which was not treated with the liquid enzymatic preparation.

The anaerobic biodegradability of the effluent with and without the enzymatic pretreatment was verified in experiments conducted in sealed glass flasks with an operational volume of 120 mL, coupled to gasometers filled with water for the collection of the gases produced. These flasks received the adapted sludge (30 mL) and the raw or enzymatically pretreated effluent (90 mL). The reactors operated in large numbers, being filled every 4 days. During this period samples were taken for pH and COD analysis. The comparison of the kinetic profile of organic matter removal (quantified as COD) allowed an evaluation of the effect of enzymatic pretreatment of the effluent on the efficiency of the anaerobic treatment. The enzymatic pretreatment of effluents with different concentrations of fats resulted in a considerable increase of biodegradability, confirmed by an accentuated decrease of COD, as can be seen in Table 2 below, which shows the results of COD removal for the different initial concentrations of fats studied, after 96 hours of reaction.

TABLE 2

| | |
|---|---|
| Initial level | Removal of COD (%) |

| of fat (mg/l) | Control Reactor | Hydrolyzed Reactor |
|---|---|---|
| 180 | 55 | 95 |
| 450 | 70 | 91 |
| 900 | 37 | 80 |
| 1200 | 19 | 80 |

Furthermore, the enzymatic pre-hydrolysis resulted in an accentuated decrease in treatment time, as shown in Table 3 below, which shows the reaction times (for 80% removal efficiency) for the initial levels of fat studied. The reduction of the COD level during the time of treatment for the effluent with high level of fat (1200 mg/L) and in natura is illustrated in FIG. 1.

TABLE 3

| | |
|---|---|
| Initial level | Reaction Time (hours) |

| of fat (mg/L) | Control Reactor | Hydrolyzed Reactor |
|---|---|---|
| 180 | 96 | 42 |
| 450 | 120 | 50 |
| 900 | 144 | 96 |
| 1200 | 192 | 96 |

### EXAMPLE 2

### Reconditioning of Anaerobic Reactors Used in the Treatment of Fat Rich Effluents.

The unclogging of an anaerobic reactor of the UASB type with 3.0 liters was evaluated by filling the reactor with the dairy effluent mentioned above. The reactor operated for 4 months, at a temperature of 35° C. and under a volumetric organic load of 4.0 kg COD/m³.day, which corresponded to a COD of about 4000 mg/L containing a level of fat around 800 mg/L. The fat present in the effluent accumulated gradually inside the reactor, causing drag of the sludge, increasing the turbidity and the ratio of solids in suspension and also resulting in a treated effluent of terrible quality. The present invention was capable of reconditioning this anaerobic reactor that was completely clogged by fats. For such it was necessary to recirculate the enzymatic preparation in a proportion of around 700 UI per Kg of reactor sludge, using as reference the standard lipase activity, during about three days. After this time, the completely clogged and inoperative reactor functioned normally again. The parameters evaluated after its unclogging indicated a notable reduction of turbidity (58% less than that obtained in the effluent before the addition of the enzymatic preparation to the reactor) and of the ratio of suspended volatile solids (SVS) (73% less) in the treated effluent, due to the drag caused by the accumulation of fats and gases in the sludge mass; there also occurred a return to the forming of larger and more active granules; and, lastly, a reduction of the COD of the effluent (55% less).

### EXAMPLE 3

### Reconditioning of Aerobic Reactors in the Treatment of Fat Rich Effluents.

The effect of the proposed enzymatic pretreatment on the biodegradation of fat rich effluents, particularly of dairy effluents, was evaluated in an aerobic biological reactor of 1.0 L receiving the in natura effluent and hydrolyzed with the preparation obtained in accordance with the present invention. The reactor operated firstly with an input constituted of the in natura effluent mentioned, containing a COD of 3000 mg/L and a fat level of about 400 mg/L, with a residence time of 24 hours. The reactor was inoculated with activated sludge originating from the treatment of domestic sewage for an initial concentration of 2500 mg SVS/L. The continuous feeding of this effluent to the reactor led to a gradual loss of the COD removal efficiency, to an increasingly worse quality of the treated effluent and also to a reduction in the sedimentation capacity of the sludge. When the enzymatic preparation began to be added in proportions of 100 UI to 1.000 UI per operating volume of the reactor, with a periodicity ranging from once to thrice a week, a considerable improvement occurred to the COD removal, as well as the obtainment of a better quality treated effluent, having less turbidity, with the sludge sedimenting much faster, which confirms the capacity of the present invention to recondition aerobic reactors having low efficiency for the removal of organic loads and an accumulation of fats.

### EXAMPLE 4

### Treatment and Retrieval of Accumulated Fats in Separator Units.

The proposed enzymatic preparation was tested on the fat removed from the surface of a fat box in an experimental dairy effluent treating unit. The addition of the enzymatic preparation at a concentration of 15 UI/g to 50 UI/g of fat, taking as reference standard lipase activity, at a temperature of 30 to 35° C., during 10 to 200 minutes, resulted in the dissolution of the fat and an accentuated increase in the concentration of free fatty acids, which demonstrates the capacity of the present invention to treat and retrieve the fats accumulated in the different separator units of treating units, such as, for example, fat boxes, water-oil separators and/or floatation units. These fats, that constitute a solid waste with high pollution potential, could be transformed into an amino acid and free fatty acid pool, which could be commercialized as an animal feed supplement, with environmental and economic advantages for the owner of the industry.

### EXAMPLE 5

### Treatment of Effluents from Abattoirs, Meat Packing Plants and Meat Processing Industries.

Abattoirs and meat packing plants produce large volumes of effluents and frequently utilize water in an inefficient manner. The consumption of water per animal slaughtered varies in accordance with the animal and the process employed by each industry, but falls between 1.0 and 8.3 m³. The residuary waters from meat packing plants contain high quantities of biodegradable organic matter, usually varying from 1100 to 2400 mg/L BOD₅, with a soluble fraction varying between 40 and 60%. The non-soluble fraction is formed by colloidal matter in suspension, in the form of fats, proteins and cellulose, which may be slowly degraded in biological reactors. The effect of the addition of the enzymatic preparation in its solid form was evaluated in an anaerobic reactor of the UASB type having 7.2 liters, treating the effluents of a meat packing plant with a COD varying between 2000 and 6200 mg/L, protein levels from 300 to 1300 mg/L and fat levels between 40 and 600 mg/L. The reactor operated with hydraulic retention times between 14 and 22 hours for a period of 80 days. During this period a gradual accumulation of fats over the sludge granules was observed through electronic photomicrography. The addition of the solid enzymatic preparation at a concentration of 0.1% (humid weight/volume of effluent) resulted in the disappearance of the white spots on the surface of the granules, indicating the accumulation of fats. In this case, the enzymatic preparation was produced in a manner as to contain a greater number of proteases to the detriment of the lipases, as established in Table 1.

### Example 6

### Cleaning of Septic Tanks

According to tests undertaken on residential septic tanks, the enzymatic preparation may be employed as an additive to improve the operation of these tanks. The addition of the enzymatic preparation in its liquid form in a proportion of 0.5 to 5.0 ml per operational volume of the tank, resulted in a reduced formation of scum, thus obtaining a cleaner skim, and an increased interval time between cleaning operations.

### EXAMPLE 7

### Cleaning Fat Boxes of Residences and Commercial Establishments.

The cleaning of residential fat boxes was immensely facilitated after the addition of 0.5 to 5 mL of the enzymatic preparation per liter of operational volume of the box, taking as reference standard lipase activity.

### EXAMPLE 8

### Enzymatic Hydrolysis Comparative Between the Enzymatic Preparation and a Commercial Product.

The comparative hydrolysis of a dairy effluent with 1200 mg/L of fat resulted in the hydrolysis efficiency of the enzymatic preparation of the present invention being approximately 10 times superior than the commercial preparation, that is, with 10 times less concentration it was possible to obtain the same effect as to the formation of monomeric units (free acids) that are more easily assimilated in later biological treatment. FIG. 2 enclosed shows the formation of monomeric units (free acids) in accordance with the hydrolysis time for the enzymatic preparation of the present invention and the imported commercial product, both added in different concentrations.

It is possible to conclude from experiments with the solid (fermented waste) or the liquid (enzymatic extract) enzymatic preparation that it is highly efficient in the enzymatic pretreatment of effluents with high levels of fats, proteins and/or carbohydrates, and especially, of effluents with high levels of fats. In this case, the following manner of addition is recommended:

a) solid enzymatic preparation: addition of 0.1 to 5.0% (humid weight/volume of effluent) of fermented waste containing 10 to 28 units of lipase per gram, for fat levels around 150 to 4000 mg/L, at temperatures of 30 to 35° C. and initial pH 7.0.

b) liquid enzymatic preparation: addition of 2 to 30% (volume/volume of effluent) of the liquid preparation containing 2220 to 6220 units of lipase per gram, for fat levels around 150 to 4000 mg/L, at temperatures of 30 to 35° C. and initial pH 7.0.

The enzymatic preparation also has the purpose of efficiently unclogging reactors, fat boxes and septic tanks that have received waste containing high levels of fats during a prolonged period. The unclogging or unblocking of these equipments may be obtained in an efficient manner by means of the addition of the enzymatic preparation in the following manner:

a) solid enzymatic preparation: addition of 0.5 to 1.5 grams of the solid preparation (containing from 10 to 28 units of lipase per gram of fermented waste) per gram of accumulated fat, equivalent to 15-50 units of lipase per gram of fat, at temperatures of 30 to 35° C.

b) liquid enzymatic preparation: addition of 2.5 to 25.0 mL of the liquid preparation (containing from 2220 to 6220 units of lipase per liter) per gram of accumulated fat, equivalent to 15-50 units of lipase per gram of fat, at temperatures of 30 to 35° C.

1. (Currently Amended) Process A process for the production of an enzymatic preparation for the treatment of treating industrial and domestic effluents with high levels of containing at least one of fats, proteins and/or carbohydrates, characterized by the fact that wherein the enzymatic preparation is produced by the fungus Penicillium restrictum fungus and obtained by a solid-state fermentation process.

2. (Currently Amended) Process The process in accordance with claim 1, characterised by the fact that the wherein a culture medium for the solid-state fermentation process is a semi-solid or solid product or waste originating from agribusiness.

3. (Currently Amended) The process Process in accordance with claim 1, characterised by the fact that wherein the enzymatic preparation is solid or liquid.

4. (Currently Amended) The process Process in accordance with claim 1, characterised by the fact that wherein the fermentation process comprises the inoculation of the inoculating an agribusiness product or waste with around about 10⁷ spores of the fungus Penicillium restrictum per gram of product or waste, with the latter said product or waste being inoculated and incubated at 30° C. in an incubator with injection of humid air in a manner as to maintain the a humidity of the product or waste between 40 and 70% during the fermentation, and fermented during a fermentation time that varies from of 24 to 72 hours to produce a fermented product, and after this the fermentation time, the ground fermented product or waste is ground and then treated to reduce its rate of humidity, in a manner as to obtain the enzymatic preparation in its a solid form with the a desired enzymatic activity.

5. (Currently Amended) The process Process in accordance with claim 1, characterised by the fact of wherein the enzymatic preparation comprises fermented solids and said process further comprises adding to the fermented solids a buffered aqueous solvent for the extraction of to extract hydrolytic enzymes from the fermented solids, with an extraction time of 5 to 60 minutes and a temperature of extraction between of 30 to 60° C.

6. (Currently Amended) A composition Composition of the enzymatic preparation for the treatment of industrial and domestic effluents with high levels of containing at least one of fats, proteins and/or carbohydrates, characterised by the fact that wherein the composition comprises an enzymatic preparation is constituted of comprising hydrolytic enzymes.

7. (Currently Amended) The composition Composition in accordance with claim 56, characterised by the fact that wherein the enzymatic preparation is constituted of comprises lipases, proteases and amylases.

8. (Currently Amended) The composition Composition in accordance with claim 56, characterised by the fact that wherein the enzymatic preparation is solid or liquid.

9. (Currently Amended) The composition Composition in accordance with claim 78, characterised by the fact that wherein the enzymatic preparation is a solid preparation is constituted of comprising lipases having enzymatic activity between from 4 to 28 units per gram of the fermented product or waste.

10. (Currently Amended) The composition Composition in accordance with claim 78, characterised by the fact that wherein the enzymatic preparation is a solid preparation is constituted of comprising proteases having enzymatic activity between from 5 to 30 units per gram of the fermented product or waste.

11. (Currently Amended) The composition Composition in accordance with claim 78, characterised by the fact that wherein the enzymatic preparation is a solid preparation is constituted of comprising amylases having enzymatic activity between from 17 to 99 units per gram of the fermented product or waste.

12. (Currently Amended) The composition Composition in accordance with claim 78, characterized by the fact that wherein the enzymatic preparation is a liquid preparation is constituted of comprising lipases having enzymatic activity between from 890 to 6220 units per litre liter of the enzymatic preparation.

13. (Currently Amended) The composition Composition in accordance with claim 78, characterised by the fact that wherein the enzymatic preparation is a liquid preparation is constituted of comprising proteases having enzymatic activity between from 1110 to 6670 units per litre liter of the enzymatic preparation.

14. (Currently Amended) The composition Composition in accordance with claim 78, characterized by the fact that wherein the enzymatic preparation is a liquid preparation is constituted of comprising proteases having enzymatic activity between from 3780 and to 22000 units per litre liter of the enzymatic preparation.

15. (Currently Amended) A process Process for the treatment of treating liquid, paste and semi-solid industrial and domestic effluents, with high levels of containing at least one of fats, proteins and/or carbohydrates, characterised by the fact of said process including a stage of enzymatic hydrolysis employing a solid or liquid enzymatic preparation, constituted of comprising lipases, proteases and amylases, wherein the enzymatic hydrolysis is conducted before the a biological treatment stage.

16. (Currently Amended) The process Process in accordance with claim 1415, characterised by the fact that the treatment process wherein the process includes the addition of adding to the effluents 0.01 to 5.0% (humid weight/volume of effluent) of the solid enzymatic preparation, containing from 10 to 28 units of lipase per gram, for levels of fat around 150 to 4000 mg/L, at temperatures between 30° C. and 35° C. and an initial pH of 7.0.

17. (Currently Amended) The process Process in accordance with claim 1415, characterised by the fact that the treatment process wherein the process includes the addition of adding to the effluents 2 to 30% (volume/volume of effluent) of the liquid enzymatic preparation, containing from 2220 to 6220 units of lipase per litre liter, for levels of fat around 150 to 4000 mg/L, at temperatures between 30° C. and 35° C. and an initial pH of 7.0.

18. (Currently Amended) A process Process for the reconditioning of clogged systems including biological reactors, fat boxes and septic tanks caused by continuous use with high levels of at least one of fats, proteins and carbohydrates, characterised by the fact of said process comprising treating the clogged systems with employing a solid or liquid enzymatic preparation, constituted of comprising hydrolytic enzymes with lipases, proteases and amylases.

19. (Currently Amended) The process Process in accordance with claim 1718, characterised by the fact of including the addition of wherein the process comprises adding to the clogged systems 0.05 to 1.5 grams of the solid enzymatic preparation (containing from 10 to 28 units of lipase per gram of the fermented product or waste) per gram of accumulated fat, equivalent to 15-50 units of lipase per gram of fat, at temperatures between 30° C. to 35° C., and wherein the solid enzymatic preparation contains from 10 to 28 units of lipase per gram of fermented product or waste.

20. (Currently Amended) Process in accordance with claim 1718, characterised by the fact of including the addition of wherein the process comprises adding to the clogged systems 2.5 to 25.0 mL of the liquid enzymatic preparation (containing from 2220 to 6220 units of lipase per litre) per gram of accumulated fat, equivalent to 15-50 units of lipase per gram of fat, at temperatures between 30° C. to 35° C., and wherein the liquid enzymatic preparation contains from 2220 to 6220 units of lipase per liter.
